(19) United States
(12) Patent Application Publication
(10) Pub. No.: US 2025/0320859 A1
(43) Pub. Date: Oct. 16, 2025

(54) FLUID CONTROL DEVICE

(71) Applicant: Murata Manufacturing Co., Ltd., Nagaokakyo-shi (JP)

(72) Inventor: Nobuhira TANAKA, Nagaokakyo-shi (JP)

(21) Appl. No.: 19/248,652

(22) Filed: Jun. 25, 2025

Related U.S. Application Data
(63) Continuation of application No. PCT/JP2023/042034, filed on Nov. 22, 2023.

(30) Foreign Application Priority Data
Dec. 26, 2022 (JP) 2022-208402

(51) Int. Cl. F04B 43/04

(52) U.S. Cl. CPC F04B 43/046

(57) ABSTRACT

A fluid control device includes a pump body, a housing, and an adhesive. The pump body includes a first external connection conductor and a second external connection conductor. The housing includes a side wall, accommodates the pump body in an inside of the housing, and has a first cavity and a second cavity extending through the side wall. The adhesive fixes the housing and a portion of the pump body and seals the inside of the housing against an outside. The first external connection conductor protrudes outside the housing through the first cavity, and the second external connection conductor protrudes outside the housing through the second cavity. The fluid control device includes an auxiliary member different from the adhesive.

### CROSS REFERENCE TO RELATED APPLICATION

This is a continuation of International Application No. PCT/JP2023/042034 filed on Nov. 22, 2023 which claims priority from Japanese Patent Application No. 2022-208402 filed on Dec. 26, 2022. The contents of these applications are incorporated herein by reference in their entireties.

### BACKGROUND OF THE DISCLOSURE

### Field of the Disclosure

The present disclosure relates to a fluid control device including a pump body configured to control a fluid, and a housing in which the pump body is mounted.

### Description of the Related Art

International Publication No. 2022/149386 describes a fluid control device. The fluid control device of International Publication No. 2022/149386 includes a pump body, an upper case member, and a lower case member. The lower case member includes a recessed portion. The pump body is accommodated in the recessed portion of the lower case member. In this state, the upper case member is disposed so as to cover the upper side of the recessed portion of the lower case member (the upper side of the pump body).

The lower case member has two cavities in a side wall. The pump body includes two external connection conductors. The two external connection conductors of the pump body are drawn outside through the respective two cavities.

The upper case member, the pump body, and the lower case member are fixed to one another by an adhesive. At this point, the adhesive is formed so as to close the two cavities. Thus, the sealability of the inside of the housing constituted by the upper case member and the lower case member is enhanced.

### BRIEF SUMMARY OF THE DISCLOSURE

However, as in a configuration described in International Publication No. 2022/149386, such two external connection conductors may be drawn from different positions in a height direction. In this case, an interval (gap) between the external connection conductor on the lower side and the upper case member in the height direction becomes wider. Thus, it is difficult to reliably seal this gap with the adhesive.

Accordingly, a possible benefit of the present disclosure is to provide a fluid control device enabling to more reliably seal a cavity through which an external connection conductor protrudes outside a housing.

A fluid control device according to an embodiment of the present disclosure includes a pump body, a housing, and an adhesive. The pump body includes a piezoelectric element, a vibration plate on which the piezoelectric element is disposed, a first feed conductor and a second feed conductor that apply a drive signal to be supplied to the piezoelectric element, a first external connection conductor connected to the first feed conductor, a second external connection conductor connected to the second feed conductor, and an auxiliary member. The housing includes a side wall, accommodates the pump body in an inside of the housing, and has a first cavity and a second cavity extending through the side wall. The adhesive fixes the housing and a portion of the pump body and seals the inside of the housing against an outside. The first external connection conductor protrudes outside the housing through the first cavity, and the second external connection conductor protrudes outside the housing through the second cavity.

The first external connection conductor and the second external connection conductor are disposed at different positions in a first direction parallel to a height direction of the side wall. The auxiliary member and the second external connection conductor are disposed at positions where the auxiliary member and the second external connection conductor overlap each other when viewed in the first direction. The first external connection conductor and the auxiliary member are disposed on the same side relative to the second external connection conductor in the first direction.

With this configuration, the auxiliary member is disposed between the second external connection conductor and the housing, thereby narrowing a gap to be filled with the adhesive, between the second external connection conductor and the housing. Thus, the adhesive is more reliably filled in the second cavity.

According to the present disclosure, the cavity through which the external connection conductor protrudes outside the housing can be more reliably sealed.

### BRIEF DESCRIPTION OF THE SEVERAL VIEWS OF THE DRAWINGS

FIG. 1 is an exploded perspective view of a fluid control device according to a first embodiment of the present disclosure.

FIG. 2 is an exploded perspective view of a pump body of the fluid control device according to the first embodiment of the present disclosure.

FIG. 3A is an enlarged perspective view of a spot of a terminal mount of the fluid control device according to the first embodiment. In FIG. 3B, a lid in FIG. 3A is removed.

FIG. 4A is an enlarged plan view of the spot of the terminal mount of the fluid control device according to the first embodiment, FIG. 4B illustrates the spot of the terminal mount when viewed from the outer end (distal end) side of the terminal mount, and FIG. 4C illustrates an A-A section in FIG. 4A.

FIG. 5 is an exploded perspective view of a fluid control device according to a second embodiment of the present disclosure.

FIG. 6A is an enlarged perspective view of a spot of a terminal mount of the fluid control device according to the second embodiment. In FIG. 6B, a lid in FIG. 6A is removed.

FIG. 7 is an exploded perspective view of a fluid control device according to a third embodiment of the present disclosure.

FIG. 8A is an enlarged perspective view of a spot of a terminal mount of the fluid control device according to the third embodiment. In FIG. 8B, a lid in FIG. 8A is removed.

FIG. 9A is an enlarged plan view of the spot of the terminal mount of the fluid control device according to the third embodiment, and FIG. 9B illustrates the spot of the terminal mount when viewed from the outer end (distal end) side of the terminal mount.

FIG. 10 is an exploded perspective view of a fluid control device according to a fourth embodiment of the present disclosure.

FIG. 11A is an enlarged perspective view of a spot of a terminal mount of the fluid control device according to the fourth embodiment. In FIG. 11B, a lid in FIG. 11A is removed.

FIG. 12A is an enlarged plan view of the spot of the terminal mount of the fluid control device according to the fourth embodiment, and FIG. 12B illustrates a B-B section in FIG. 12A.

FIG. 13 describes one example of a manufacturing method of a first flat plate of each fluid control device according to the embodiments of the present disclosure.

FIGS. 14A to 14F illustrate various derived examples of an auxiliary member.

### DETAILED DESCRIPTION OF THE DISCLOSURE

### First Embodiment

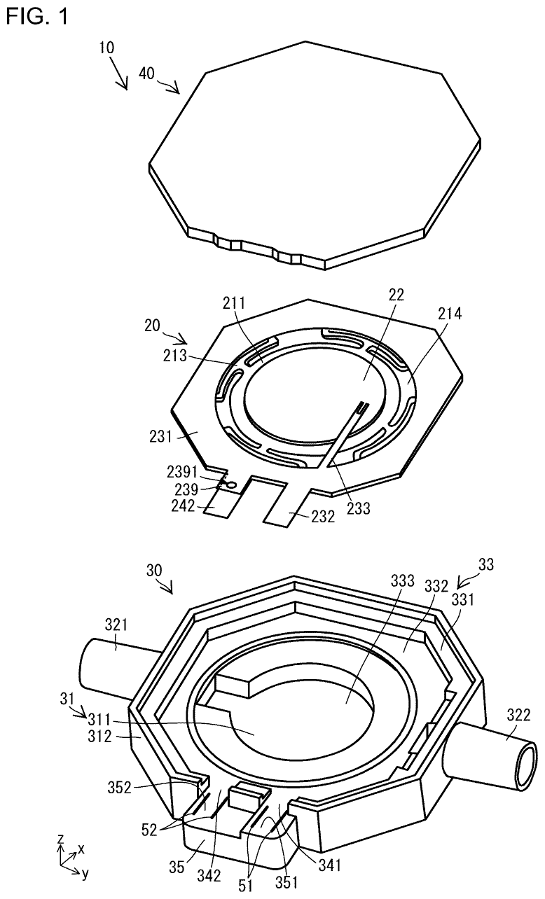

A fluid control device according to a first embodiment of the present disclosure will be described with reference to the drawings. FIG. 1 is an exploded perspective view of the fluid control device according to the first embodiment of the present disclosure. Note that the drawings given in the embodiments including the present embodiment may exaggerate the shapes of the constituent elements in part or as a whole to make the configuration of each fluid control device easier to understand.

As FIG. 1 illustrates, a fluid control device 10 includes a pump body 20, a main housing 30, and a lid 40. The main housing 30 and the lid 40 constitute a “housing” of the present disclosure.

### Configuration of Housing

The main housing 30 includes a main member 31, a nozzle 321, and a nozzle 322. The main member 31, the nozzle 321, and the nozzle 322 are shaped as one body by using an insulating resin material, for example.

The main member 31 includes a bottom wall 311 and a side wall 312. The side wall 312 stands upright in a direction orthogonal to a main surface of the bottom wall 311, and, with this shape, the main member 31 thus includes a recessed part 33 recessed from the top surface side. The direction where the side wall 312 stands upright, that is, a height direction of the side wall 312, a height direction of the main member 31, and, furthermore, a direction parallel to a height direction of the main housing 30 (a Z-axis direction in FIG. 1) each correspond to a “first direction” of the present disclosure.

The recessed part 33 has three levels of depth and is constituted by a recessed portion 331, a recessed portion 332, and a recessed portion 333. The recessed portion 332 is deeper than the recessed portion 331, and the recessed portion 333 is deeper than the recessed portion 332. The recessed portion 333 is disposed at the center in a plan view of the main member 31 (when viewed in a direction orthogonal to the bottom wall 311 (in the Z-axis direction in FIG. 1)). The recessed portion 332 is disposed along an outer periphery of the recessed portion 333. The recessed portion 331 is disposed along an outer periphery of the recessed portion 332.

The main member 31 includes a terminal mount 35 protruding outward from the side wall 312. A surface of the terminal mount 35 has different levels and includes a first surface 351 and a second surface 352. The second surface 352 is disposed at a position lower than the first surface 351.

A first cavity 341 and a second cavity 342 are formed at a spot, on the side wall 312 of the main member 31, where the terminal mount 35 protrudes. The first cavity 341 and the second cavity 342 each have a shape extending through the side wall 312 and further to the recessed portion 332.

The nozzle 321 and the nozzle 322 are mounted to the side wall 312 of the main member 31 at positions different from the position where the terminal mount 35 is disposed. A through hole of the nozzle 321 communicates with the recessed portion 333 through a through hole (not illustrated) extending through the side wall 312 in a thickness direction. A through hole of the nozzle 322 communicates with the recessed portion 332 through a through hole (not illustrated) extending through the side wall 312 in the thickness direction.

The lid 40 is a flat plate and is made of, for example, an insulating resin material. The outside shape of the lid 40 is substantially the same as the shape of the inner side of the side wall 312 of the main housing 30, that is, the outside shape of the recessed portion 331.

The lid 40 is fitted in the recessed portion 331 of the main housing 30, and the housing is thereby formed. As described above, the lid 40 covers openings of the recessed portion 332 and the recessed portion 333 of the main housing 30, and an inner space of the housing is thereby realized.

### Configuration of Pump Body 20

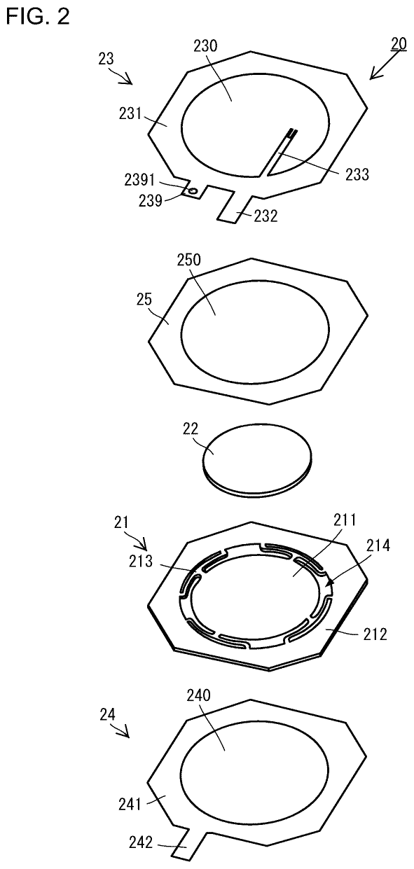

FIG. 2 is an exploded perspective view of the pump body of the fluid control device according to the first embodiment of the present disclosure. As FIG. 2 illustrates, the pump body 20 includes a vibration plate 21, a piezoelectric element 22, a first flat plate 23, a second flat plate 24, and an insulating layer 25.

The vibration plate 21 is constituted by a conductor. The vibration plate 21 includes a center flat plate 211, a frame body 212, and multiple coupling members 213. The shape in plan view (the shape when viewed in a thickness direction) of the center flat plate 211 is a circular flat plate. The frame body 212 is a flat plate and is disposed on the outer side relative to an outer edge of the center flat plate 211. The frame body 212 has a circular opening at the center. The center flat plate 211 is disposed in this opening.

The multiple coupling members 213 each have a beam shape. The multiple coupling members 213 are disposed between the center flat plate 211 and the frame body 212. The multiple coupling members 213 are connected to an outer edge of the center flat plate 211 and an inner edge of the frame body 212. Multiple voids 214 extend through the vibration plate 21 in the thickness direction. The multiple voids 214 are disposed between the center flat plate 211 and the frame body 212. The multiple voids 214 are portions, in a region between the center flat plate 211 and the frame body 212, surrounded by the center flat plate 211, the frame body 212, and the multiple coupling members 213.

The piezoelectric element 22 includes a piezoelectric having a disk shape and a drive electrode. The drive electrode is formed on each of both main surfaces of the piezoelectric.

The first flat plate 23 includes a main body 231, a first external connection conductor 232, a first feed conductor 233, and an auxiliary member 239. The main body 231, the first external connection conductor 232, the first feed conductor 233, and the auxiliary member 239 are shaped as one body by using one flat-plate conductor.

The main body 231 has an annular shape and has an opening 230. The main body 231 has substantially the same shape as the frame body 212 of the vibration plate 21. The first external connection conductor 232 has a straight-line shape having a predetermined width. The first external connection conductor 232 protrudes outward from an outer peripheral end of the main body 231. The first feed conductor 233 has a straight-line shape having a predetermined width. The first feed conductor 233 protrudes in the opening 230 of the main body 231 from an inner peripheral end of the main body 231.

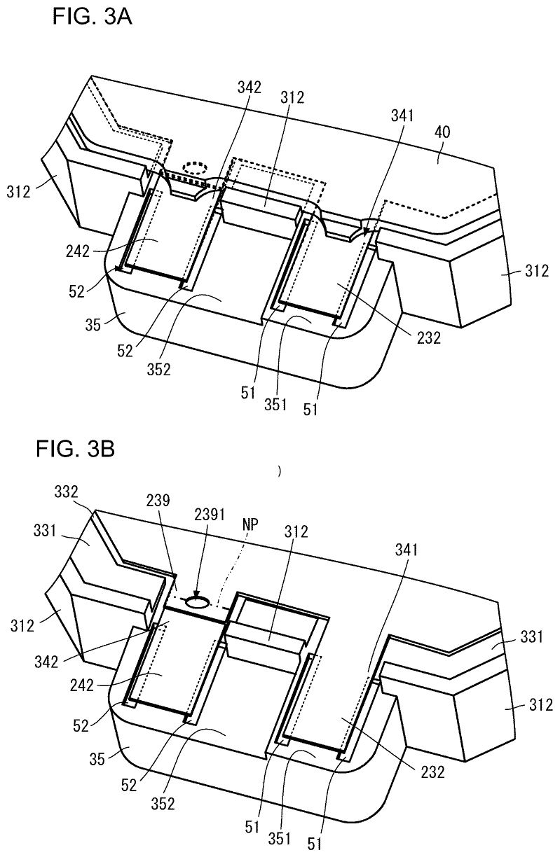

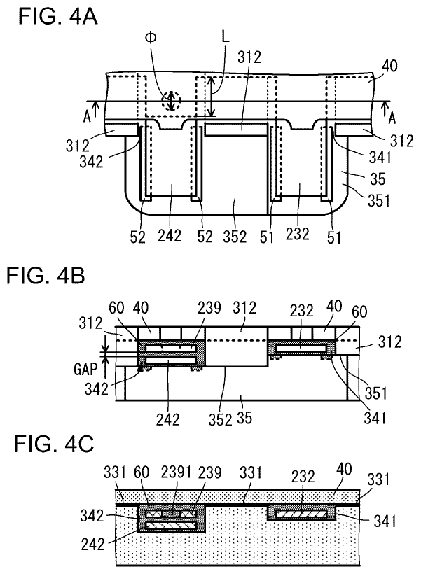

The auxiliary member 239 has a straight-line shape having a predetermined width. The auxiliary member 239 protrudes outward from the outer peripheral end of the main body 231 by a length L (refer to FIG. 4A). The auxiliary member 239 has an opening 2391. The opening shape of the opening 2391 is, for example, a circle as illustrated in the figure. The opening 2391 corresponds to a “first through hole” of the present disclosure.

The second flat plate 24 includes a main body 241 and a second external connection conductor 242. The main body 241 and the second external connection conductor 242 are shaped as one body by using one flat-plate conductor.

The main body 241 has an annular shape and has an opening 240. The main body 241 has substantially the same shape as the frame body 212 of the vibration plate 21. The main body 241 corresponds to a second feed conductor of the present disclosure. The second external connection conductor 242 has a straight-line shape having a predetermined width. The second external connection conductor 242 protrudes outward from an outer peripheral end of the main body 241.

The insulating layer 25 has an annular shape and has an opening 250. The insulating layer 25 has substantially the same shape as the frame body 212 of the vibration plate 21.

The piezoelectric element 22, the insulating layer 25, and the first flat plate 23 are disposed on the upper side relative to the vibration plate 21. The second flat plate 24 is disposed on the lower side relative to the vibration plate 21.

More specifically, the piezoelectric element 22 is mounted on an upper surface of the center flat plate 211 of the vibration plate 21. While the piezoelectric element 22 is physically fixed to the center flat plate 211, the drive electrode on the lower side of the piezoelectric element 22 is electrically connected to the center flat plate 211.

The insulating layer 25 is disposed on an upper surface of the frame body 212 of the vibration plate 21. The first flat plate 23 is disposed so that the main body 231 overlaps an upper surface of the insulating layer 25. The first feed conductor 233 of the first flat plate 23 is electrically connected to the drive electrode on the upper side of the piezoelectric element 22. The second flat plate 24 is disposed so that the main body 241 overlaps a lower surface of the frame body 212 of the vibration plate 21. The main body 241 of the second flat plate 24 is electrically connected to the frame body 212 of the vibration plate 21 while being physically fixed thereto.

### Fixation Aspect of Pump Body 20 to Housing

The pump body 20 is fitted in the recessed portion 332. Accordingly, the pump body 20 is accommodated inside the housing. At this point, in the pump body 20, the second flat plate 24 is positioned on the bottom wall 311 side, and the first flat plate 23 is positioned on the lid 40 side. A space formed on the lower side relative to the pump body 20 by the recessed portion 333 communicates with the through hole of the nozzle 321. A space formed on the upper side relative to the pump body 20 by the recessed portion 332 communicates with the through hole of the nozzle 322.

In this state, the main housing 30 and the pump body 20 are fixed to each other by an adhesive applied to a bottom surface of the recessed portion 332. Further, a surface of the recessed portion 331 of the main housing 30 and an inner wall surface of the side wall 312 adhere to the lid 40 with an adhesive (not illustrated).

Thus, the pump body 20 is fixed in a space surrounded by the main housing 30 and the lid 40 (a space inside the housing). Further, as will be described in more detail below, such an inside of the housing accommodating the pump body 20 is sealed against the outside except for the through holes of the nozzle 321 and the nozzle 322, by sealing the first cavity 341 and the second cavity 342 by the adhesive.

### Outline of Fluid Control Operation of Fluid Control Device 10

The fluid control device 10 is supplied with a drive signal from the outside through the first external connection conductor 232 and the second external connection conductor 242. The drive signal is supplied to the piezoelectric element through the first feed conductor 233 of the first flat plate 23 and the main body 241 (the second feed conductor) of the second flat plate 24.

The piezoelectric element 22 of the pump body 20 is strained by the drive signal. The center flat plate 211 of the vibration plate 21 vibrates due to such a strain of the piezoelectric element 22. With this vibration, a fluid (for example, a gas such as air) is sucked inside the housing through the through hole of the nozzle 321 and is sent out through the through hole of the nozzle 322.

At this point, the fluid control device 10 can suck and send out the fluid with high efficiency by sealing (hermetically) the inside of the housing against the outside.

### Structures of First External Connection Conductor 232, Second External Connection Conductor 242, First Cavity 341, and Second Cavity 342

FIG. 3A is an enlarged perspective view of a spot of the terminal mount of the fluid control device according to the first embodiment. In FIG. 3B, the lid in FIG. 3A is removed. Note that illustration of the adhesive is omitted in FIGS. 3A and 3B. FIG. 4A is an enlarged plan view of the spot of the terminal mount of the fluid control device according to the first embodiment, FIG. 4B illustrates the spot of the terminal mount when viewed from the outer end (distal end) side of the terminal mount, and FIG. 4C illustrates an A-A section in FIG. 4A.

### First Cavity 341

The first external connection conductor 232, through the first cavity 341, protrudes outside the main housing 30 (to the outer side relative to the side wall 312) and extends to the first surface 351 of the terminal mount 35. Thus, in the first cavity 341, the first external connection conductor 232 is disposed between the lid 40 and the main housing 30.

The first cavity 341 is filled with an adhesive 60 that is an insulator. The first surface 351 of the terminal mount 35 is at a position higher than the position of the second surface 352 and is close to the lid 40. Thus, an interval (gap) between the lid 40 and the first external connection conductor 232 is short. Accordingly, the first cavity 341 is easily filled with the adhesive 60. Thus, the first cavity 341 is sealed easily and more reliably by the adhesive 60.

### Second Cavity 342

The second external connection conductor 242, through the second cavity 342, protrudes outside the main housing 30 (to the outer side relative to the side wall 312) and extends to the second surface 352 of the terminal mount 35.

The auxiliary member 239 is disposed on the upper side relative to the second external connection conductor 242 (on the first external connection conductor 232 side in a height direction of the housing of the fluid control device 10). The width of the auxiliary member 239 is substantially the same as the width of the second external connection conductor 242. The auxiliary member 239 is disposed at a position where the auxiliary member 239 faces the second external connection conductor 242. The auxiliary member 239 is disposed at a position where the auxiliary member 239 faces a portion, of the second external connection conductor 242, that is positioned on the proximal end side connected to the main body 241 and is overlapping the lid 40.

Thus, in the second cavity 342, the auxiliary member 239 and the second external connection conductor 242 are disposed between the lid 40 and the main housing 30.

The second cavity 342 is filled with the adhesive 60 that is an insulator. The second surface 352 of the terminal mount 35 is at a position lower than the position of the first surface 351 and is far from the lid 40. Thus, an interval (gap) between the lid 40 and the second external connection conductor 242 is long.

However, in this configuration, the auxiliary member 239 is disposed between the lid 40 and the second external connection conductor 242. Thus, the adhesive 60 is filled between the lid 40 and the auxiliary member 239 and between the auxiliary member 239 and the second external connection conductor 242. An interval between the lid 40 and the auxiliary member 239 and an interval between the auxiliary member 239 and the second external connection conductor 242 are each shorter than the interval between the lid 40 and the second external connection conductor 242.

Accordingly, the second cavity 342 can be easily filled with the adhesive 60 by providing the auxiliary member 239, even when the second external connection conductor 242 is far from the lid 40. Thus, the second cavity 342 can be sealed easily and more reliably by the adhesive 60.

Further, the auxiliary member 239 has the opening 2391. The opening 2391 is a hole extending through the auxiliary member 239 from an upper surface to a lower surface. A portion, of the auxiliary member 239, in which the opening 2391 is formed has less conductor remaining than the other portion of the auxiliary member 239, and the portion thus corresponds to a “narrow width portion” of the present disclosure. With this configuration, when the adhesive 60 is applied to the upper surface side of the auxiliary member 239, the adhesive 60 easily enters between the auxiliary member 239 and the second external connection conductor 242. Thus, the adhesive 60 is easily filled between the auxiliary member 239 and the second external connection conductor 242. Accordingly, the second cavity 342 can be sealed easily and more reliably by the adhesive 60.

At this point, the length L of the auxiliary member 239 may be at least twice an interval GAP between the auxiliary member 239 and the second external connection conductor 242. With this configuration, the adhesive 60 that has entered between the auxiliary member 239 and the second external connection conductor 242 hardly flows out therefrom. Thus, a state where the adhesive 60 is filled between the auxiliary member 239 and the second external connection conductor 242 is maintained more reliably.

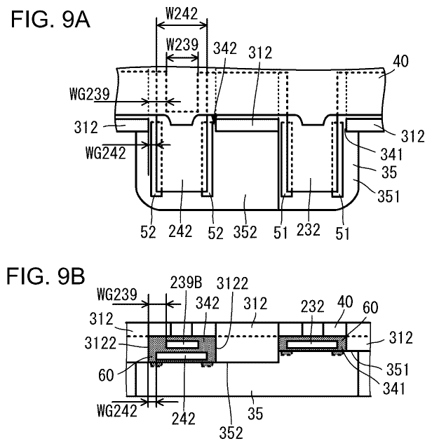

In addition, the width of the auxiliary member 239 (refer to, for example, a width W239 in FIG. 9B) may be at least twice the interval GAP between the auxiliary member 239 and the second external connection conductor 242. With this configuration, the adhesive 60 that has entered between the auxiliary member 239 and the second external connection conductor 242 hardly flows out therefrom. Thus, a state where the adhesive 60 is filled between the auxiliary member 239 and the second external connection conductor 242 is maintained more reliably.

Note that the auxiliary member 239 is not necessarily shaped with the first flat plate 23 into one body. However, by shaping the auxiliary member 239 with the first flat plate 23 into one body, the auxiliary member 239 can be easily and reliably positioned at a position where the positional relationship is established in which the auxiliary member 239 passes through the second cavity 342 when the first external connection conductor 232 passes through the first cavity 341.

In addition, the first surface 351 has a groove 51, and the second surface 352 has a groove 52. But, the groove 51 and the groove 52 can be omitted. However, providing the groove 51 and the groove 52 exhibits the following effects.

The first external connection conductor 232 is fixed to the first surface 351 by the adhesive 60. At this point, the groove 51 is provided in the first surface 351 and thus accommodates, for example, a portion of the adhesive 60 that has been excessively applied. Thus, the adhesive 60 is disposed on a bottom surface and a side surface of the first external connection conductor 232 without excess or deficiency. Accordingly, the first external connection conductor 232 is more reliably fixed to the terminal mount 35, thereby being able to achieve more reliable electrical connection to the outside. Similarly, the second surface 352 has the groove 52, and the adhesive 60 is thereby disposed on a bottom surface and a side surface of the second external connection conductor 242 without excess or deficiency. Accordingly, the second external connection conductor 242 is more reliably fixed to the terminal mount 35, thereby being able to achieve more reliable electrical connection to the outside.

In addition, the adhesive 60 fixing the first external connection conductor 232 to the first surface 351 is connected to the adhesive 60 sealing the first cavity 341. The adhesive 60 fixing the second external connection conductor 242 to the second surface 352 is connected to the adhesive 60 sealing the second cavity 342. Thus, with the adhesive 60, the fluid control device 10 can maintain simultaneously the sealed state of each of the first cavity 341 and the second cavity 342 and the fixed state of each of the first external connection conductor 232 and the second external connection conductor 242. The fluid control device 10 can stably maintain the sealed state and the fixed state.

### Second Embodiment

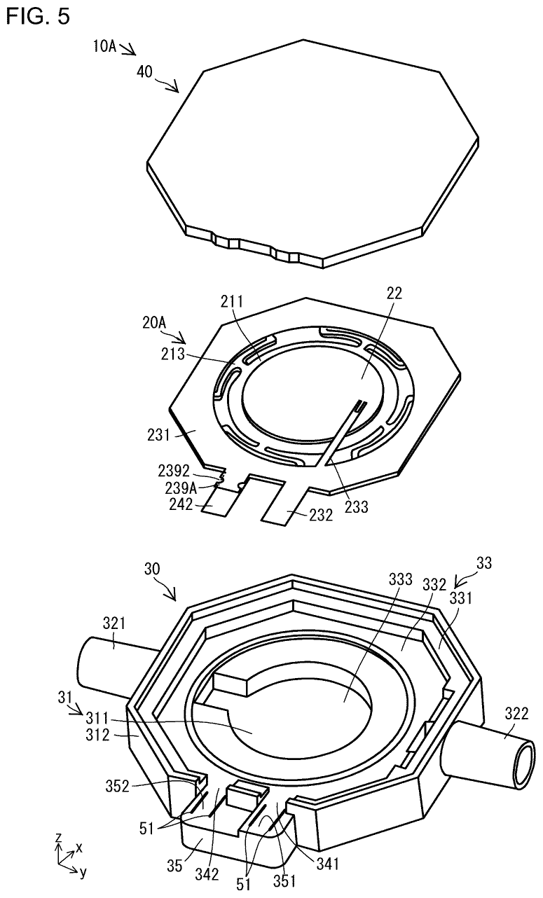

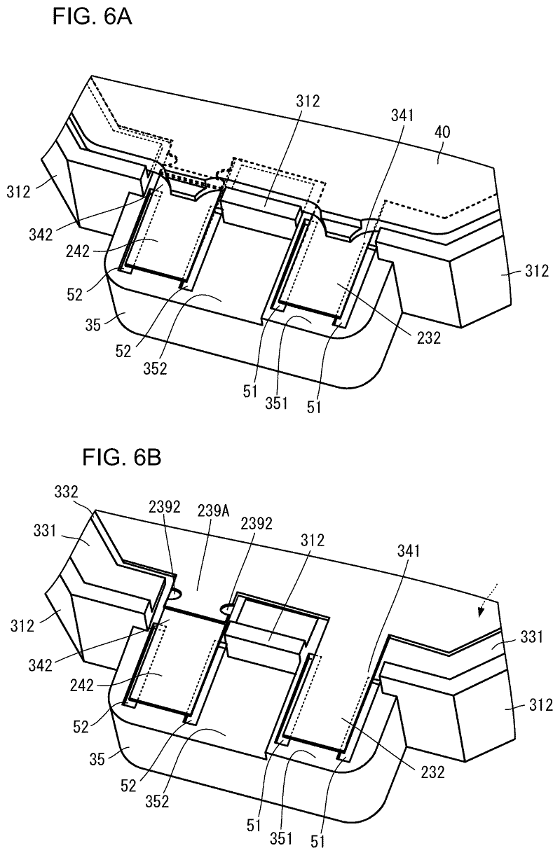

A fluid control device according to a second embodiment of the present disclosure will be described with reference to the drawings. FIG. 5 is an exploded perspective view of the fluid control device according to the second embodiment of the present disclosure. FIG. 6A is an enlarged perspective view of a spot of a terminal mount of the fluid control device according to the second embodiment. In FIG. 6B, a lid in FIG. 6A is removed. Note that illustration of an adhesive is omitted in FIGS. 6A and 6B.

As FIGS. 5, 6A, and 6B illustrate, a fluid control device 10A according to the second embodiment differs from the fluid control device 10 according to the first embodiment in the shape of an auxiliary member 239A of a pump body 20A. The other constituents of the fluid control device 10A are similar to those of the fluid control device 10 according to the first embodiment, and description of the similar parts will be omitted.

The auxiliary member 239A has a groove 2392. The groove 2392 has a shape recessed from an end on each of both sides of the auxiliary member 239A toward the center in a width direction. A portion, of the auxiliary member 239A, in which the grooves 2392 are formed, has a conductor part narrower than that of the other portion and serves as a narrow width portion.

With such a configuration, an adhesive 60 supplied from the lid 40 side of the auxiliary member 239A easily flows into a space between the auxiliary member 239A and a second external connection conductor 242 through the grooves 2392. Thus, the fluid control device 10A exhibits actions and effects similar to those exhibited by the fluid control device 10.

### Third Embodiment

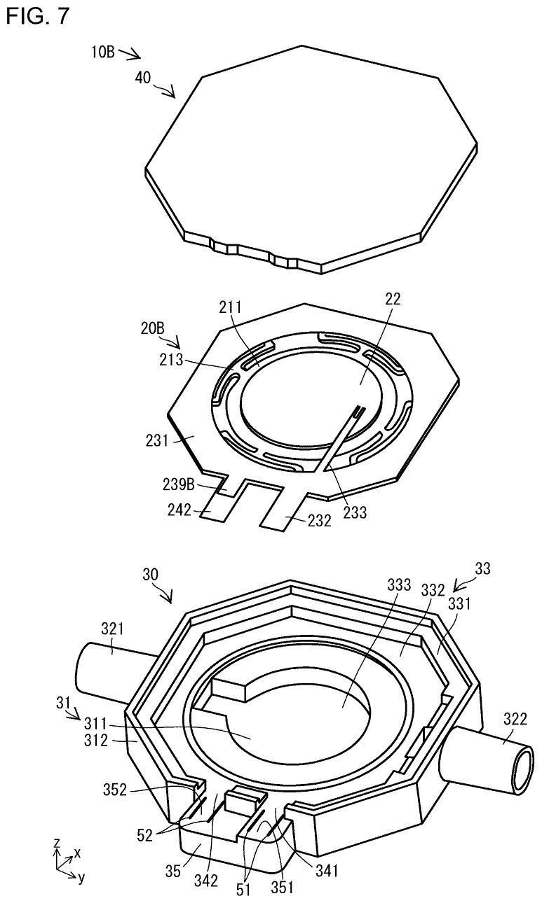

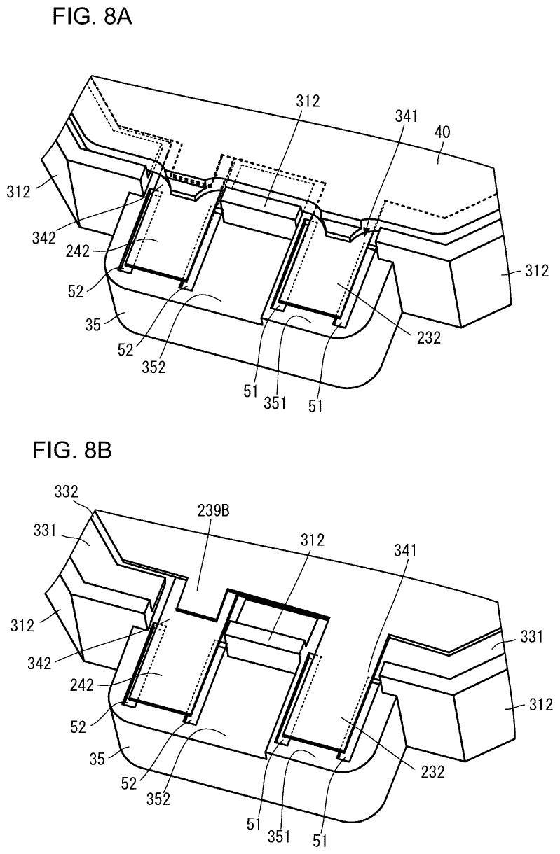

A fluid control device according to a third embodiment of the present disclosure will be described with reference to the drawings. FIG. 7 is an exploded perspective view of the fluid control device according to the third embodiment of the present disclosure. FIG. 8A is an enlarged perspective view of a spot of a terminal mount of the fluid control device according to the third embodiment. In FIG. 8B, a lid in FIG. 8A is removed. Note that illustration of an adhesive is omitted in FIGS. 8A and 8B. FIG. 9A is an enlarged plan view of the spot of the terminal mount of the fluid control device according to the third embodiment, and FIG. 9B illustrates the spot of the terminal mount when viewed from the outer end (distal end) side of the terminal mount.

As FIGS. 7, 8A, 8B, 9A, and 9B illustrate, a fluid control device 10B according to the third embodiment differs from the fluid control device 10 according to the first embodiment in the shape of an auxiliary member 239B of a pump body 20B. The other constituents of the fluid control device 10B are similar to those of the fluid control device 10 according to the first embodiment, and description of the similar parts will be omitted.

The auxiliary member 239B does not have an opening or a groove. The width W239 of the auxiliary member 239B is narrower than a width W242 of a second external connection conductor 242. That is, the entire auxiliary member 239B is a narrow width portion.

The auxiliary member 239B is disposed at a position where the auxiliary member 239B allows ends on both sides of the second external connection conductor 242 to be exposed to the lid 40 side. That is, a distance WG239 between a side surface of the auxiliary member 239B and a side end surface 3122 of a second cavity 342 of a side wall 312 is longer than a distance WG242 between a side surface of the second external connection conductor 242 and the side end surface 3122 of the second cavity 342 of the side wall 312.

With such a configuration, an adhesive 60 supplied from the lid 40 side of the auxiliary member 239B easily flows into a space between the auxiliary member 239B and the second external connection conductor 242. Thus, the fluid control device 10B exhibits actions and effects similar to those exhibited by the fluid control device 10.

Note that the width W239 of the auxiliary member 239B may be substantially the same as or the same as the width W242 of the second external connection conductor 242, but such above-described ease of flow is hardly achieved. Accordingly, the width W239 of the auxiliary member 239B may be narrower than the width W242 of the second external connection conductor 242.

However, the width W239 of the auxiliary member 239B may be at least half the width W242 of the second external connection conductor 242. Due to this configuration, the adhesive 60 is easily filled between the auxiliary member 239B and the second external connection conductor 242. Moreover, when the width W239 of the auxiliary member 239B is about half the width W242 of the second external connection conductor 242, the ease of filling the adhesive 60 between the auxiliary member 239B and the second external connection conductor 242 and the action and effect of sealing the second cavity 342 by using the auxiliary member 239B can be achieved in a well-balanced manner. Note that this concept is not limited to the width W239 of the auxiliary member 239B of the third embodiment and can also be applied to the diameter Φ of the opening 2391 of the first embodiment and the depth of the groove 2392 of the second embodiment.

### Fourth Embodiment

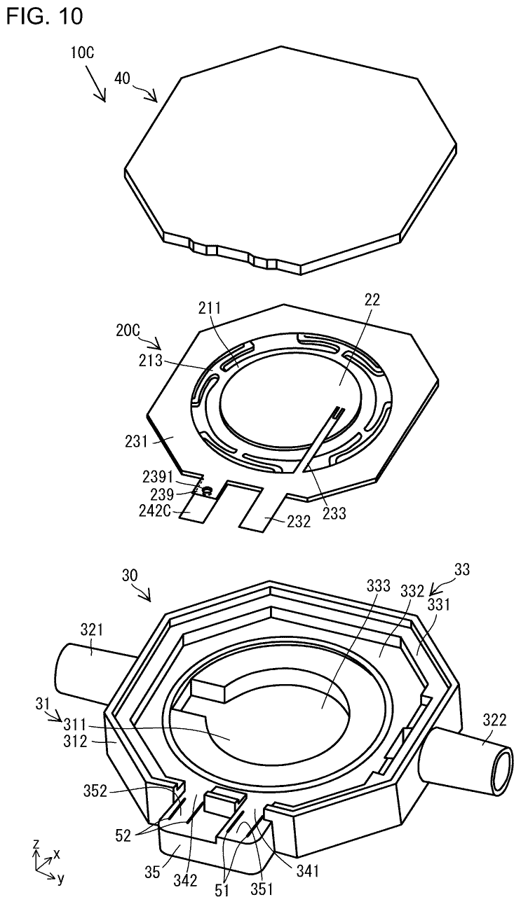

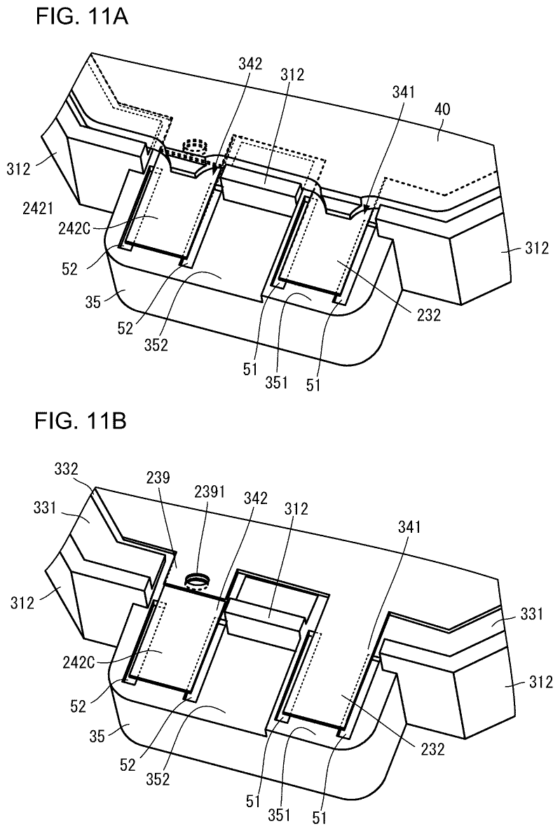

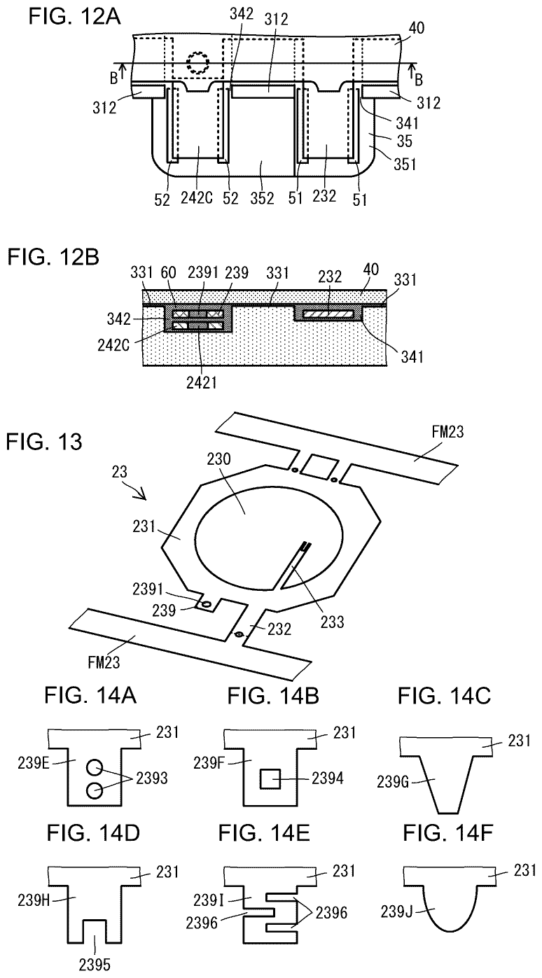

A fluid control device according to a fourth embodiment of the present disclosure will be described with reference to the drawings. FIG. 10 is an exploded perspective view of the fluid control device according to the fourth embodiment of the present disclosure. FIG. 11A is an enlarged perspective view of a spot of a terminal mount of the fluid control device according to the fourth embodiment. In FIG. 11B, a lid in FIG. 11A is removed. Note that illustration of an adhesive is omitted in FIGS. 11A and 11B. FIG. 12A is an enlarged plan view of the spot of the terminal mount of the fluid control device according to the fourth embodiment, and FIG. 12B illustrates a B-B section in FIG. 12A.

As FIGS. 10, 11A, 11B, 12A, and 12B illustrate, a fluid control device 10C according to the fourth embodiment differs from the fluid control device 10 according to the first embodiment in the shape of a second external connection conductor 242C of a pump body 20C. The other constituents of the fluid control device 10C are similar to those of the fluid control device 10 according to the first embodiment, and description of the similar parts will be omitted.

The second external connection conductor 242C has a through hole 2421. The through hole 2421 is formed at a position where the through hole 2421 overlaps an opening 2391 of an auxiliary member 239. The through hole 2421 corresponds to a second through hole of the present disclosure.

With such a configuration, an adhesive 60 on the lower side relative to the second external connection conductor 242C also flows into a space between the auxiliary member 239 and the second external connection conductor 242C. That is, the adhesive 60 for fixing the second external connection conductor 242C to a second surface 352 also flows into the space between the auxiliary member 239 and the second external connection conductor 242C. Accordingly, the adhesive 60 easily flows into the space between the auxiliary member 239 and the second external connection conductor 242C. Thus, the fluid control device 10C exhibits actions and effects similar to those exhibited by the fluid control device 10.

Note that the through hole 2421 and the opening 2391 do not necessarily overlap each other. However, the through hole 2421 and the opening 2391 overlap each other, thereby being able to obtain a facing area of a conductor part of the auxiliary member 239 and a conductor part of the second external connection conductor 242C. Thus, the fixing strength between the auxiliary member 239 and the second external connection conductor 242C can be increased.

### One Example of Manufacturing Method of First Flat Plate

FIG. 13 describes one example of a manufacturing method of the first flat plate of each fluid control device according to the embodiments of the present disclosure. As FIG. 13 illustrates, the first flat plate 23 is supported by frames FM23 disposed on both sides. This structure can be obtained by punching, with a mold, a flat plate having a size large enough to arrange and form multiple first flat plates 23.

When such punching is performed, the main body 231 of the first flat plate 23 and one frame FM23 are required to be separated by a distance allowing the first external connection conductor 232 to be formed. Accordingly, the auxiliary member 239 is disposed, between the main body 231 and the frame FM23, in a portion to be punched out. Thus, even without forming the auxiliary member 239 as a body separated from the main body 231 including the first external connection conductor 232, the auxiliary member 239 can be formed by utilizing a part that is originally punched out and discarded. Moreover, the auxiliary member 239 and the first external connection conductor 232 can be easily arranged in the horizontal direction, and the auxiliary member 239 can be easily and precisely positioned in relation to the first external connection conductor 232.

### Derived Examples of Shape of Auxiliary Member

FIGS. 14A to 14F illustrate various derived examples of the auxiliary member.

In FIG. 14A, an auxiliary member 239E has multiple through holes 2393. In FIG. 14B, an auxiliary member 239F has a through hole 2394 having a rectangular opening shape. In FIG. 14C, an auxiliary member 239G has a tapered shape.

In FIG. 14D, an auxiliary member 239H includes a recessed portion 2395 recessed from a distal end to the main body 231 side. In FIG. 14E, an auxiliary member 239I has multiple grooves 2396 recessed from ends on both sides. In FIG. 14F, an auxiliary member 239J has a semielliptical shape in plan view.

A common feature of the above-described auxiliary members is that the auxiliary members have a narrow width portion. By providing the narrow width portion in the auxiliary member in such an above way, the adhesive can easily flow into a space between the auxiliary member and the second external connection conductor as described above.

In addition, each of the above-described embodiments describes the example where the auxiliary member is connected to the main body 231 of the first flat plate 23 and shaped with the first flat plate 23 into one body. However, the auxiliary member may be separated from the main body 231. In addition, the material of the auxiliary member is not limited to a conductive material but may be an insulating material.

Note that appropriate combinations of the above-described embodiments, manufacturing example, and derived examples are possible, and an action and an effect according to each combination can be exhibited.
(1) A fluid control device including: a pump body including a piezoelectric element, a vibration plate on which the piezoelectric element is disposed, a first feed conductor and a second feed conductor that apply a drive signal to be supplied to the piezoelectric element, a first external connection conductor connected to the first feed conductor, a second external connection conductor connected to the second feed conductor, and an auxiliary member; a housing including a side wall and accommodating the pump body in an inside of the housing, the housing having a first cavity and a second cavity extending through the side wall; and an adhesive fixing the housing and a portion of the pump body and sealing the inside of the housing against an outside, in which the first external connection conductor protrudes outside the housing through the first cavity, the second external connection conductor protrudes outside the housing through the second cavity, the first external connection conductor and the second external connection conductor are disposed at different positions in a first direction parallel to a height direction of the side wall, the auxiliary member and the second external connection conductor are disposed at positions where the auxiliary member and the second external connection conductor overlap each other when viewed in the first direction, and the first external connection conductor and the auxiliary member are disposed on the same side relative to the second external connection conductor in the first direction.
(2) The fluid control device according to the item (1), in which the auxiliary member includes a narrow width portion narrower than the second external connection conductor in a width direction.
(3) The fluid control device according to the item (2), in which the auxiliary member includes the narrow width portion by having a first through hole or a groove.
(4) The fluid control device according to any one of the items (1) to (3), in which a length between both ends of the auxiliary member in a direction parallel to a direction where the second external connection conductor protrudes is at least twice an interval between the auxiliary member and the second external connection conductor.
(5) The fluid control device according to any one of the items (1) to (4), in which a width between both ends of the auxiliary member in a direction orthogonal to a direction where the second external connection conductor protrudes and to a direction where the second external connection conductor and the auxiliary member are arranged is at least twice an interval between the auxiliary member and the second external connection conductor.
(6) The fluid control device according to any one of the items (1) to (5), in which a distance between the auxiliary member and a side end surface of the second cavity is longer than a distance between the second external connection conductor and the side end surface of the second cavity.
(7) The fluid control device according to any one of the items (1) to (6), in which the second external connection conductor has a second through hole in a portion facing the auxiliary member.
(8) The fluid control device according to any one of the items (1) to (7), in which the housing includes a main housing including the side wall and a recessed portion accommodating the pump body, and a lid covering the recessed portion of the main housing, and a space surrounded by the main housing and the lid constitutes the inside of the housing.
(9) The fluid control device according to any one of the items (1) to (8), in which the auxiliary member is shaped with the first external connection conductor into one body.
(10) The fluid control device according to any one of the items (1) to (9), including: a first flat plate and a second flat plate each being conductive, in which the first flat plate and the second flat plate are disposed with the piezoelectric element and the vibration plate interposed therebetween in the first direction, the first feed conductor, the first external connection conductor, and the auxiliary member are formed by using the first flat plate, and the second feed conductor and the second external connection conductor are formed by using the second flat plate.
10, 10A, 10B, 10C fluid control device
20, 20A, 20B, 20C pump body
21 vibration plate
22 piezoelectric element
23 first flat plate
24 second flat plate
25 insulating layer
30 main housing
31 main member
33 recessed part
35 terminal mount
40 lid
51, 52 groove
60 adhesive
211 center flat plate
212 frame body
213 coupling member
214 void
230 opening
231 main body
232 first external connection conductor
233 first feed conductor
239, 239A, 239B, 239E, 239F, 239G, 239H, 2391, 239J auxiliary member
240 opening
241 main body
242, 242C second external connection conductor
250 opening
311 bottom wall
312 side wall
321, 322 nozzle
331, 332, 333 recessed portion
341 first cavity
342 second cavity
351 first surface
352 second surface
2391 opening
2392 groove
2393, 2394 through hole
2395 recessed portion
2396 groove
2421 through hole
3122 side end surface
FM23 frame

1. A fluid control device comprising:
a pump body including a piezoelectric element, a vibration plate on which the piezoelectric element is disposed, a first feed conductor and a second feed conductor configured to apply a drive signal to be supplied to the piezoelectric element, a first external connection conductor connected to the first feed conductor, a second external connection conductor connected to the second feed conductor, and an auxiliary member;
a housing including a side wall and accommodating the pump body in an inside of the housing, the housing having a first cavity and a second cavity extending through the side wall; and
an adhesive fixing the housing and a portion of the pump body and sealing the inside of the housing against an outside, wherein
the first external connection conductor protrudes outside the housing through the first cavity,
the second external connection conductor protrudes outside the housing through the second cavity,
the first external connection conductor and the second external connection conductor are disposed at different positions in a first direction parallel to a height direction of the side wall,
the auxiliary member and the second external connection conductor are disposed at positions where the auxiliary member and the second external connection conductor overlap each other when viewed in the first direction, and
the first external connection conductor and the auxiliary member are disposed on a same side relative to the second external connection conductor in the first direction.

2. The fluid control device according to claim 1, wherein
the auxiliary member includes a narrow width portion narrower than the second external connection conductor in a width direction.

3. The fluid control device according to claim 2, wherein
the auxiliary member includes the narrow width portion by having a first through hole or a groove.

4. The fluid control device according to claim 1, wherein
a length between both ends of the auxiliary member in a direction parallel to a direction where the second external connection conductor protrudes is at least twice an interval between the auxiliary member and the second external connection conductor.

5. The fluid control device according to claim 1, wherein
a width between both ends of the auxiliary member in a direction orthogonal to a direction where the second external connection conductor protrudes and to a direction where the second external connection conductor and the auxiliary member are arranged is at least twice an interval between the auxiliary member and the second external connection conductor.

6. The fluid control device according to claim 1, wherein
a distance between the auxiliary member and a side end surface of the second cavity is longer than a distance between the second external connection conductor and the side end surface of the second cavity.

7. The fluid control device according to claim 1, wherein
the second external connection conductor has a second through hole in a portion facing the auxiliary member.

8. The fluid control device according to claim 1, wherein
the housing includes
a main housing including the side wall and a recessed portion accommodating the pump body, and
a lid covering the recessed portion of the main housing, and
a space surrounded by the main housing and the lid constitutes the inside of the housing.

9. The fluid control device according to claim 1, wherein
the auxiliary member is shaped with the first external connection conductor into one body.

10. The fluid control device according to claim 1, comprising:
a first flat plate and a second flat plate each being conductive, wherein
the first flat plate and the second flat plate are disposed with the piezoelectric element and the vibration plate interposed therebetween in the first direction,
the first feed conductor, the first external connection conductor, and the auxiliary member are portions of the first flat plate, and
the second feed conductor and the second external connection conductor are portions of the second flat plate.

11. The fluid control device according to claim 2, wherein
a length between both ends of the auxiliary member in a direction parallel to a direction where the second external connection conductor protrudes is at least twice an interval between the auxiliary member and the second external

12. The fluid control device according to claim 3, wherein
a length between both ends of the auxiliary member in a direction parallel to a direction where the second external connection conductor protrudes is at least twice an interval between the auxiliary member and the second external connection conductor.

13. The fluid control device according to claim 2, wherein
a width between both ends of the auxiliary member in a direction orthogonal to a direction where the second external connection conductor protrudes and to a direction where the second external connection conductor and the auxiliary member are arranged is at least twice an interval between the auxiliary member and the second external connection conductor.

14. The fluid control device according to claim 3, wherein
a width between both ends of the auxiliary member in a direction orthogonal to a direction where the second external connection conductor protrudes and to a direction where the second external connection conductor and the auxiliary member are arranged is at least twice an interval between the auxiliary member and the second external connection conductor.

15. The fluid control device according to claim 4, wherein
a width between both ends of the auxiliary member in a direction orthogonal to a direction where the second external connection conductor protrudes and to a direction where the second external connection conductor and the auxiliary member are arranged is at least twice an interval between the auxiliary member and the second external connection conductor.

16. The fluid control device according to claim 2, wherein
a distance between the auxiliary member and a side end surface of the second cavity is longer than a distance between the second external connection conductor and the side end surface of the second cavity.

17. The fluid control device according to claim 3, wherein
a distance between the auxiliary member and a side end surface of the second cavity is longer than a distance between the second external connection conductor and the side end surface of the second cavity.

18. The fluid control device according to claim 4, wherein
a distance between the auxiliary member and a side end surface of the second cavity is longer than a distance between the second external connection conductor and the side end surface of the second cavity.

19. The fluid control device according to claim 5, wherein
a distance between the auxiliary member and a side end surface of the second cavity is longer than a distance between the second external connection conductor and the side end surface of the second cavity.

20. The fluid control device according to claim 2, wherein
the second external connection conductor has a second through hole in a portion facing the auxiliary member.
